(19) United States
(12) Patent Application Publication
(10) Pub. No.: US 2010/0027154 A1
(43) Pub. Date: Feb. 4, 2010

(54) FLYING HEIGHT CONTROL DEVICE FOR MAGNETIC HEAD AND MAGNETIC DISK DEVICE

(75) Inventor: Koji Sonoda, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/477,663

(22) Filed: Jun. 3, 2009

(30) Foreign Application Priority Data
Jul. 30, 2008 (JP) 2008-196169

(51) Int. Cl. G11B 21/02; G11B 33/14

(52) U.S. Cl. 360/75; 360/97.02; G9B/21.003; G9B/33.035

(57) ABSTRACT

A floating amount of the magnetic head is controlled. The disk device has a temperature or humidity sensor and a controller. The controller monitors the detected temperature or humidity and retracts the magnetic head to an area where the circumferential speed is fastest, such as at the outermost side of the flying guarantee area of the magnetic disk, if the temperature or humidity is a predetermined value or more. The lubricant transferred from the magnetic disk to the magnetic head can be removed, and the increase of the flying height of the magnetic head can be suppressed.

### CROSS-REFERENCE TO RELATED APPLICATION

This application is based upon and claims the benefit of priority of the prior Japanese Patent Application No. 2008-196169, filed on Jul. 30, 2008, the entire contents of which are incorporated herein by reference.

### FIELD

The present invention relates to a flying height control device for controlling a flying height of a magnetic head from a magnetic disk surface and a magnetic disk device, and more particularly to a flying height control device and a magnetic disk device for guaranteeing stable operation even in a high temperature high humidity environment.

### RELATED ART

In order to implement high recording density of a magnetic disk device, a flying height of a head from the recording surface of the magnetic disk must be decreased, and in recent years a 5 nm order flying height has been implemented.

Currently magnetic disk devices are used not only for notebook type personal computers, but also for portable equipment and mobile equipment, for which reliability under a high temperature high humidity environment is demanded. The flying height of the recording/reproducing element of the magnetic head, which greatly influences reliability, is decreased by thermal expansion in areas around the magnetic recording/reproducing element at high temperatures, and is decreased by the decrease of positive pressure which is applied to the magnetic head in high humidity (e.g. Brian D. Strom, Shuyu Zhang, Sung Chang Lee, Andrei Khurshudov and George W. Tyndall, “Effects of Humid Air on Air-Bearing Flying Height”, IEEE Transactions on Magnetics, Vol. 43, No. 7, 2007. P. 3301).

If the flying height of a magnetic head drops, the head more easily crashes with the micro protrusions on the magnetic disk surface, and since dispersion of clearance in each head exists within the tolerance of the mechanism, flying height cannot be set to be lower than the tolerance of the flying height if the above mentioned contact to the media is considered.

In order to prevent this drop of flying height in a high temperature high humidity environment, a magnetic disk is device having a function to adjust the flying height according to the environment has been proposed.

An example of the proposed method is that the clearance of the head and the recording surface of the magnetic disk is controlled by enclosing a heater in the magnetic head, and generating thermal expansion of the magnetic head by turning the heater ON, so that the surface of the head protrudes in the magnetic disk direction (thermal protrusion: TPR).

In other words, it is proposed that a temperature/humidity sensor and a table of predetermined proportional coefficients of the flying height, which change due to the temperature/humidity change, are provided in the magnetic disk device, and the table is referred to according to the detected temperature/humidity value to determine a corresponding proportional coefficient, the flying height change is detected based on the detected temperature, humidity and proportional coefficient, and the flying height is adjusted (e.g. Japanese Patent Application Laid-Open No. 2006-269005).

Also in order to prevent a head crash in an environment outside a predetermined range, such as high temperature, high humidity and pressure change, it is proposed that the rotation frequency of the spindle motor is changed outside a predetermined temperature, humidity and pressure, or the magnetic head is moved to a position where the flying height of the disk is the maximum by a seek operation, so that the drop of the flying height of the magnetic head is prevented (e.g. Japanese Patent Application Laid-Open No. H11-176068).

The prior art concerns a drop in flying height due to thermal expansion of the recording/reproducing element portion and due to positive pressure under a high temperature and high humidity environment. In other words, is the concept of the prior art is that the power supply amount and the wind pressure are adjusted so that the flying height of the magnetic head does not become lower than a predetermined flying height, in order to prevent contact between the head and the disk, which is caused when the flying height of the magnetic head drops in the high temperature high humidity environment.

On the other hand, when inventors invested the flying height change in the height temperature and high humidity environment, it was confirmed that the flying height decreases in a short time, but then increases as the operating time advances.

This is because the lubricating film on the surface of the magnetic disk is easily transferred to the surface of the magnetic head in a high temperature and high humidity environment. If the transferred lubricating film accumulates on the surface of the magnetic head, the lubricant is formed as a layer on the magnetic disk face side of the recording and reading elements of the magnetic head, and the flying height, when viewed from the recording and reading elements, increases as time elapses.

If the flying height increases, the level of signals to be reproduced drops, and the probability of an error to be generated increases. Also if data is recorded in a high flying height state, a pattern, which is insufficiently magnetized, is written due to the drop in recording capability, and an unrecoverable error occurs, which is a more serious problem.

With these phenomena, change occurs as time elapses, and the mechanism of transfer of the lubricating film is complicated, therefore it is difficult to determine the proportional coefficient of the flying height change with respect to the temperature/humidity change. Also in the case of the prior art, which aims at preventing a drop in the flying height due to the temporal change of air pressure, the position at which the flying height is at maximum is around the center of the disk if the positive pressure and the negative pressure of the slider are considered, therefore an increase in the flying height due to the adhesion of lubricant cannot be controlled.

### SUMMARY OF THE INVENTION

With the foregoing in view, it is an object of the present invention to provide a head flying height control device and magnetic disk device to improve at least the read characteristics, even in a high temperature and high humidity environment.

In order to achieve above object, one embodiment of a magnetic disk device has a magnetic head that floats by rotation of a magnetic disk, an actuator that moves the magnetic head in a radius direction of the magnetic disk, a temperature sensor that measures a temperature inside an enclosure, and a control circuit that judges whether a detected temperature of the temperature sensor is a predetermined value or more, and controls the magnetic head to be retracted to the outermost position of the magnetic disk when the detected temperature is the predetermined value or more.

Further, in order to achieve above object, another embodiment of a magnetic disk device has a magnetic head that floats by rotation of a magnetic disk, an actuator that moves the magnetic head in a radius direction of the magnetic disk, a humidity sensor that measures a humidity inside an enclosure, and a control circuit that judges whether a detected humidity of the humidity sensor is a predetermined value or more, and controls the magnetic head to be retracted to the outermost position of the magnetic disk when the detected humidity is the predetermined value or more.

Furthermore, in order to achieve above object, one embodiment of a flying height control device for a magnetic head for moving a magnetic head that floats by rotation of a magnetic disk using an actuator in a radius direction of the magnetic disk, has a temperature sensor that measures a temperature inside an enclosure, and a control circuit that judges whether a detected temperature of the temperature sensor is a predetermined value or more, and controls the magnetic head to be retracted to the outermost position of the magnetic disk when the detected temperature is the predetermined value or more.

Since the magnetic head is retracted to an area where the circumferential speed is fastest, such as at the outermost side of the flying guarantee area of the magnetic disk, if the temperature or humidity is a predetermined value or more, the lubricant transferred from the magnetic disk to the magnetic head can be removed, and the increase of the flying height of the magnetic head can be suppressed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an external view depicting an embodiment of a magnetic disk device of the present invention;

FIG. 2 is a cross-sectional view of the magnetic head in FIG. 1;

FIG. 3 is a diagram of an explanation the change of flying height in a high temperature environment;

FIG. 4 is a diagram of an explanation the change of flying height in a high humidity environment;

FIG. 5 is a diagram of an explanation the floating height amount of the magnetic head in FIG. 2;

FIG. 6 is a diagram of an explanation the floating height amount of the magnetic head in FIG. 2 in a high temperature environment and a high humidity environment;

FIG. 7 is a diagram depicting an embodiment of the flying height control of the present invention;

FIG. 8 is a circuit block diagram of the magnetic disk device in FIG. 1;

FIG. 9 is a block diagram of the read channel in FIG. 8;

FIG. 10 is a flow chart depicting the flying height control processing according to an embodiment of the present invention;

FIG. 11 is a diagram of an explanation in one embodiment in a high temperature environment; and

FIG. 12 is a diagram of an explanation in one embodiment in a high humidity environment.

### DESCRIPTION OF THE PREFERRED EMBODIMENTS

Embodiments of the present invention will now be described in the sequence of the magnetic disk device, flying height control for the magnetic head and other embodiments, however the present invention is not limited to these embodiments.

### (Magnetic Disk Device)

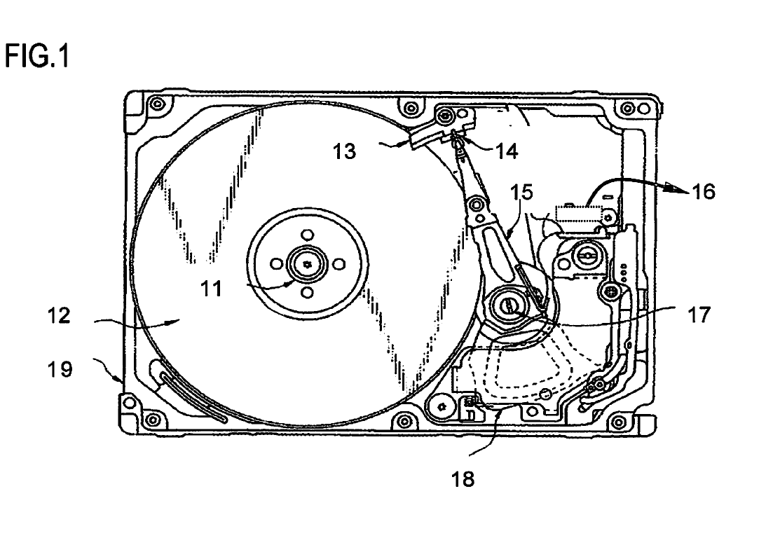

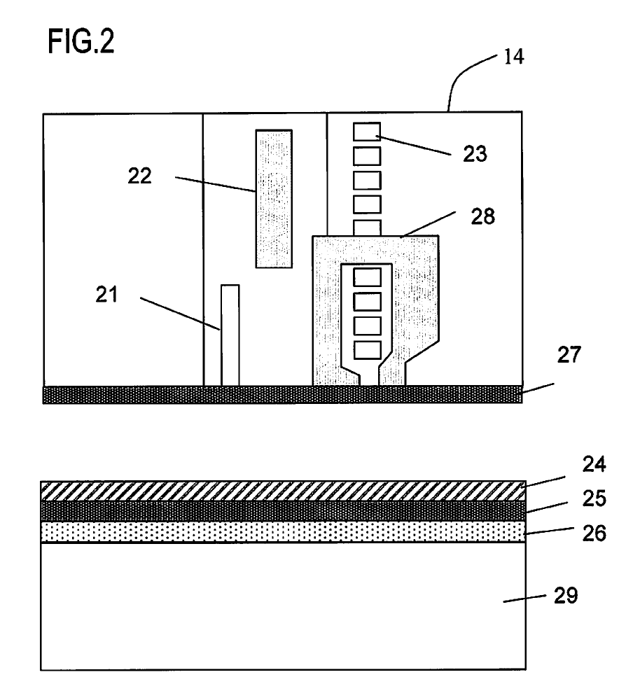

FIG. 1 is an external view depicting an embodiment of a magnetic disk device of the present invention. FIG. 2 is a cross-sectional view of the magnetic head in FIG. 1. As FIG. 1 shows, the magnetic disk device 19 has a magnetic disk 12, a magnetic head 14 including a head slider, an actuator 15 that supports the magnetic head 14, a voice coil motor (VCM) 18 and a circuit board.

On the circuit board, a head IC and a temperature/humidity sensor 16 are installed. For the is temperature sensor, a thermocouple, a thermistor, a temperature sensor IC, or a band gap base temperature sensor, for example, can be used. For the humidity sensor, a resistance type or capacitance type polymer humidity sensor, for example, can be used. A moisture absorbent, such as silica gel and activated carbon, which is not illustrated, is attached to a cover air hole, and is connected to an outside device via a diffusion duct.

The magnetic disk 12 is mounted on a spindle motor 11 and rotates, and the actuator 15 is installed on a pivot 17, and positions the magnetic head 14 at an arbitrary radius position of the magnetic disk 12 by the voice coil motor (VCM) 18.

A ramp load mechanism 13 is a mechanism to park the magnetic head 14 which is retracted from the magnetic disk 12. The magnetic disk device of the present embodiment has the ramp load mechanism 13, but the effects of the present invention can be implemented just the same for a contact start stop type magnetic disk device in which the magnetic head 14 stands by at a predetermined area of the magnetic disk 12 when the device is stopping.

FIG. 2 is a cross-sectional view of the magnetic head 14 in FIG. 1, sectioned in parallel with the circumferential direction of the magnetic disk 12. A recording element, composed of a recording coil 23 and recoding core 28, and a reproducing element 21 are disposed in the magnetic head 14. For the reproducing element 21, a GMR (Giant Magneto-Resistance) element and TMR (Tunneling Magneto-Resistance) element are used.

A diamond-like carbon (DLC) protective film 27 is formed on the surface of the magnetic head 14. Since the surface energy of the diamond-like carbon (DLC) protective film 27 is high, lubricating film, water vapor and other contaminants easily adhere. Therefore according to the present embodiment, a low surface energy treatment is performed on the surface of the magnetic head 14. The low surface energy treatment can be performed by injecting fluorine ions or coating fluorine-contained resin.

In the case of the magnetic disk 12, on the other hand, a magnetic film 26 (including an SUL layer in the case of a vertical recording disk) is formed on a substrate 29, and a diamond-like carbon (DLC) protective film 25 is formed thereon, and a lubricating film 24 is formed on the top surface.

In this lubricating film 24, the amounts of components absorbed by the diamond-like carbon (DLC) protective film 25, which is an under-layer film, changes depending on the coating conditions and processing conditions. For example, the amounts of absorbed components increase by performing heating processing or UV irradiation processing.

If the amount of absorbed components is large, the amount of the lubricating film 24 to be transferred to the magnetic head 14 can be decreased, but if it is too large, the lubrication characteristics deteriorate, so the preferable absorption rate is 60 to 80%. The amount of the absorbed components is measured by soaking the media in a fluorine-contained solvent and measuring the change of the film thickness after soaking. In other words, when the change of film thickness is smaller, the amount of absorbed components is larger.

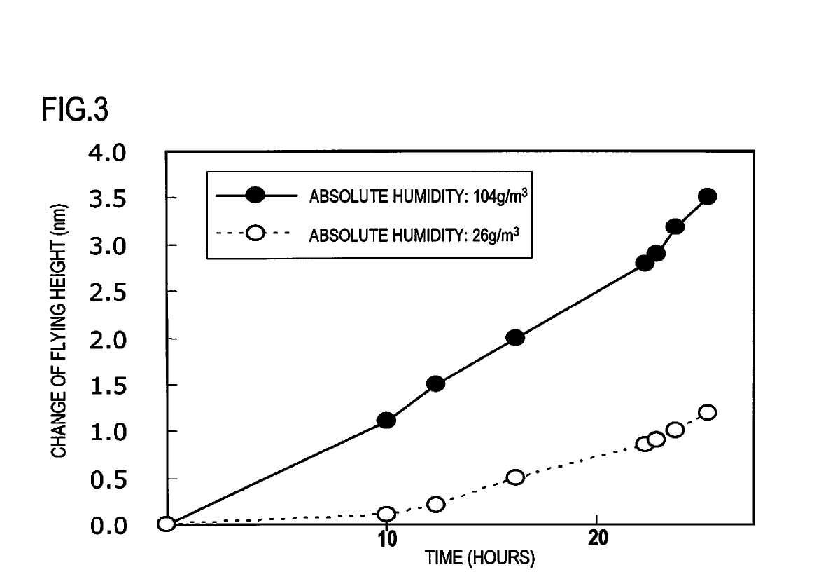

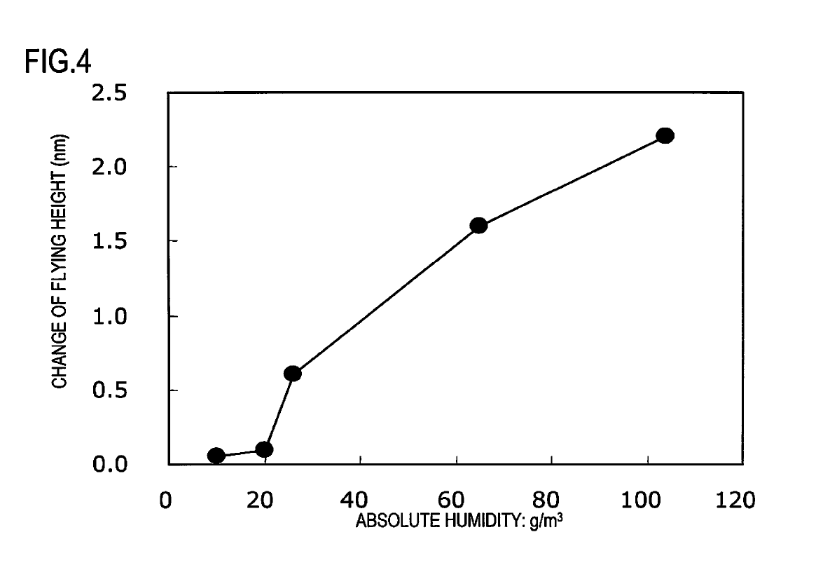

FIG. 3 and FIG. 4 are graphs depicting the result of measuring the change of flying height vs time. First the change of flying height vs time in a high temperature environment is measured in the magnetic disk device having the configuration in FIG. 1, under an environment of a 60° C. temperature, 20% RH humidity (absolute humidity: 26 g/m³) and under an environment of a 60° C. temperature, 80% RH is humidity (absolute humidity: 104 g/m³), while the magnetic head performs a random seek operation. A fixed pattern was recorded on the outer circumference (30 mm radius) of the magnetic disk, and the flying height was measured using the later mentioned Wallace method. The design value of the flying height is 5 nm.

FIG. 3 shows the measurement result, where the abscissa is time (hours) and the ordinate (nanometers) is the change of the flying height. As FIG. 3 shows, when the temperature is high, the flying height of the magnetic head tends to increase as time (hours) elapses. This tendency is not considered in the conventional flying height adjustment.

Even if the temperature is the same, the change of the flying height is lager as the absolute humidity is higher. In particular, in an environment where the humidity is 80% RH (absolute humidity: 104 g/m³), the change is 1.2 nm at 10 hours of operation, and is 3.0 nm at 20 hours of operation. This change is major since the design value (at time “0” in FIG. 3) is 5 nm.

This is because the lubricating film on the surface of the magnetic disk is easily transferred to the surface of the magnetic head in a high temperature and high humidity environment. If the transferred lubricating film accumulates on the surface of the magnetic head, the lubricant is formed as a layer on the magnetic disk face side of the recording and reading elements of the magnetic head, and the flying height, when viewed from the recording and reading elements, increases as time elapses.

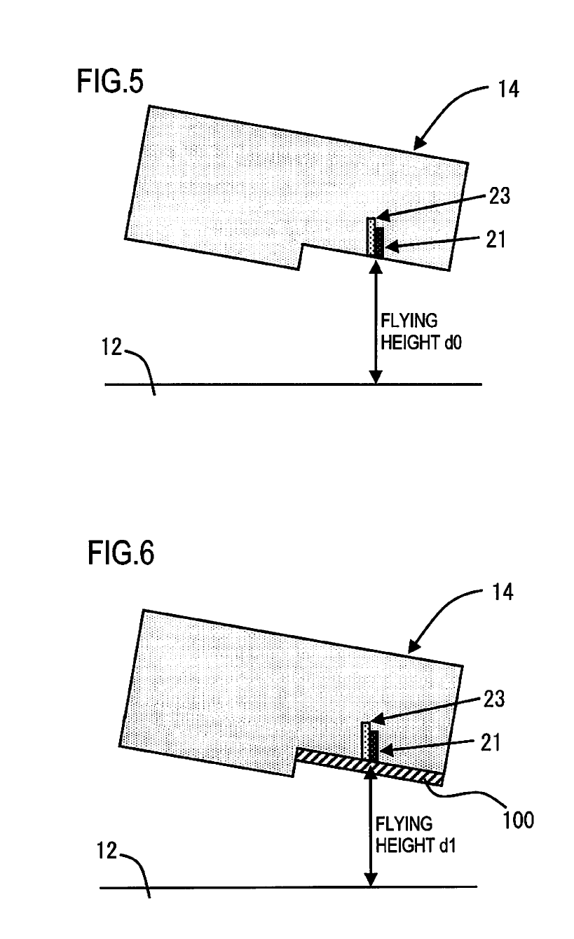

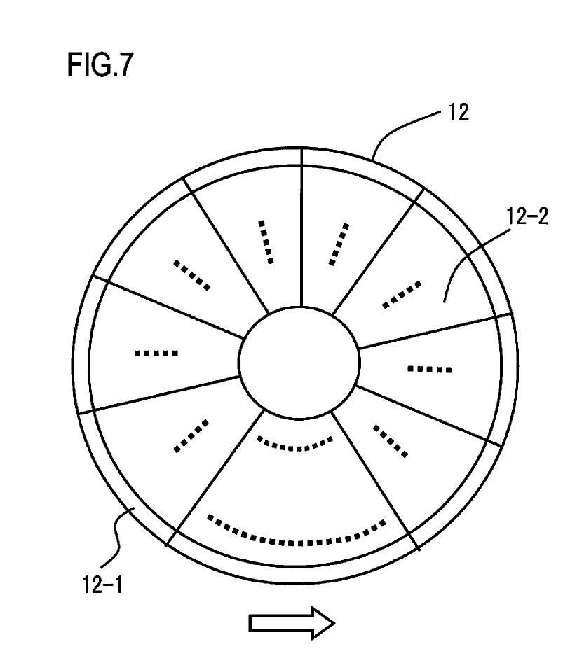

As FIG. 5 shows, when the flying height is defined as a distance (space) d0 between the reading element 21 of the magnetic head (slider) 14 and the magnetic disk 12, the lubricant 100 is formed as a layer on the magnetic disk 12 face side of the recording and reading elements 21 and 23 of the magnetic head 14 in the high temperature and high is humidity environment, as shown in FIG. 6, and the distance (flying height) d1 between the recording and reading elements 21 and 23 and the magnetic disk 12 increases as time elapses.

In the same way, the change of the flying height for a predetermined time (10 hours) is measured at a 60° C. temperature in the magnetic disk device having the configuration in FIG. 1, using absolute humidity as a parameter. FIG. 4 shows the measurement result, where the abscissa is the absolute humidity (g/m³), and the ordinate (nanometers) is the change of the flying height.

As FIG. 4 shows, if the absolute humidity exceeds 20 g/m³, the change of the flying height increases suddenly. In other words, if the temperature is high and the absolute humidity is high, then the water vapor absorption amount on the surface of the magnetic disk increases, as a result, the absorbed components in the lubrication film decrease, and the lubricating film is transferred more easily to the surface of the magnetic head.

FIG. 7 is a diagram depicting an embodiment of the flying height control of the present invention, and shows the surface of the magnetic disk 12. According to the present invention, if the time, when the temperature is higher than a predetermined value, continues for a predetermined time, based on the results in FIG. 3 and FIG. 4, the magnetic head 12 is retracted to a position at which the circumferential speed is as fast as possible, such as the outermost side of the flying guarantee area of the magnetic disk 12. In the same way, if the time, when the humidity is higher than a predetermined value, continues for a predetermined time, the magnetic head 12 is retracted to a position where the circumferential speed is fast.

When the circumferential speed is faster, the lubricating film 100 transferred onto the surface of the magnetic head 12 makes easily flow to hardly accumulate. Therefore when the temperature and humidity are monitored during operation, the magnetic head 12 is retracted to a position where the circumferential speed is faster, when the time at which the temperature is higher than a predetermined value, continues for a predetermined time, or when the time at which the humidity is higher than a predetermined value continues for a predetermined time. Therefore, the lubricant 100 does not accumulate very much, and an increase in the flying height of the magnetic head 12 can be suppressed, and as a result, the read/write characteristics can be improved.

As FIG. 7 shows, a flying guarantee area 12-1 and data guarantee area 12-2 are normally defined on the magnetic disk 12. The former is an area where flying was guaranteed in the floating test at inspection before shipment of the magnetic disk, but data cannot be guaranteed because of the potential danger of contact with the magnetic head during ramp load, for example.

Therefore data is written only in the data guarantee area 12-2, and the recording density is determined by this data volume. The above mentioned retraction area to be set need not be within the data guarantee area 12-2, since the data is not recorded or reproduced in the retraction area.

When the flying height is measured in the retraction area, recording a fixed pattern in the data guarantee area 12-2 is not preferable since recording density drops. The flying height can be measured simply by using an average value of the outputs in one rotation, and influence is minor even if a part of the pattern is deleted, so there is no problem if the retraction area is set outside the data guarantee area.

Therefore it is preferable to set the retraction area outside the data guarantee area and within the flying guarantee area 12-1, which is the outermost track where the is circumferential speed is fast.

The predetermined value of the temperature is preferably about 60° C. This is because the viscosity of the lubricating film decreases and the film becomes more easily transferred to the magnetic head if this temperature is exceeded.

The absolute humidity can be approximated by the following Expression (1), using the amount of water vapor (g/m³) contained in the unit volume of air, based on Tetens' expression and relative humidity.

Absolute humidity (g/m³)=6.11×10^{(7.5T/(T+237.3)}×relative humidity (%) (1)

where T is temperature (° C.)

The predetermined value of the absolute humidity is preferably about 20 g/m³, as FIG. 4 shows. This is because the absorbed amount of water vapor on the surface of the magnetic disk increases and the absorbed components in the under-layer film decreases, and as a result, the lubricating film becomes more easily transferred to the surface of the magnetic head if this humidity is exceeded.

### (Flying Height Control for Magnetic Head)

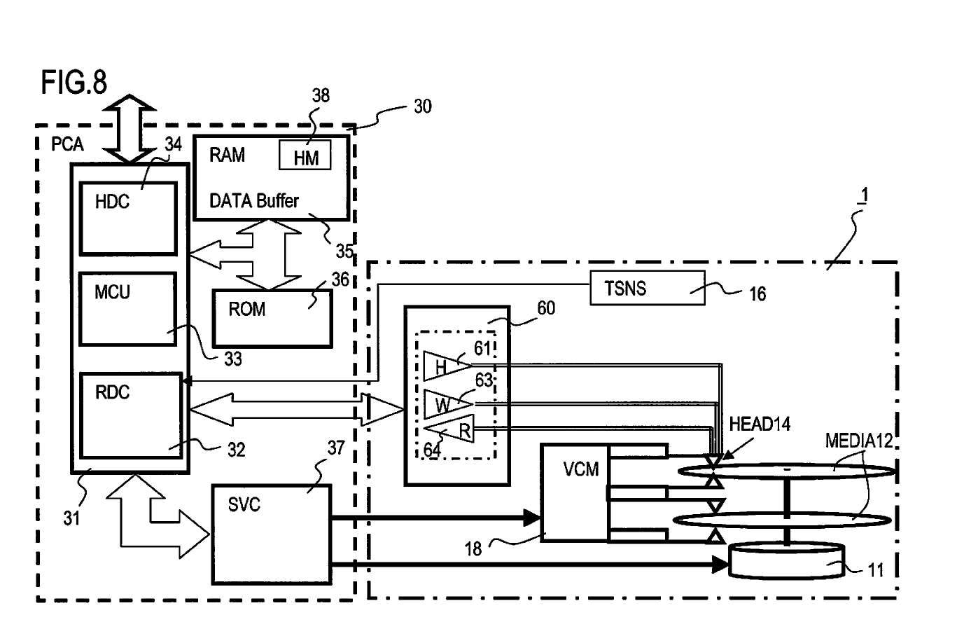

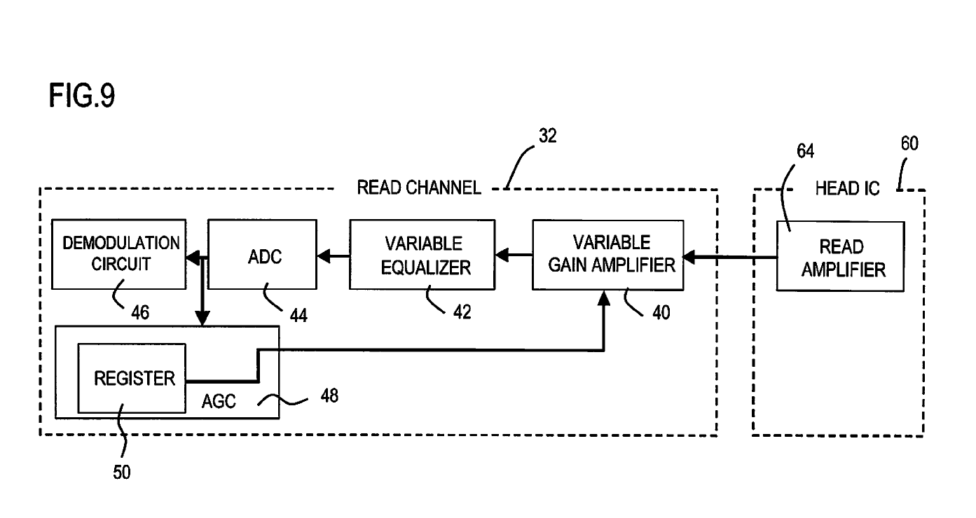

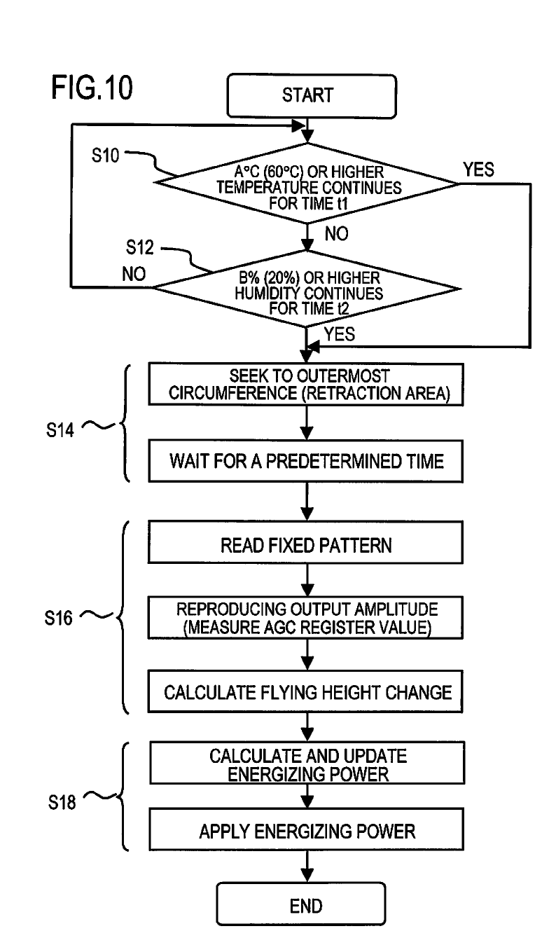

FIG. 8 is a circuit block diagram of the magnetic disk device of the present invention, FIG. 9 is a block diagram of the read channel in FIG. 8, and FIG. 10 is a flow chart depicting the flying height control processing according to an embodiment of the present invention. In FIG. 8, composing elements the same as FIG. 1 and FIG. 2 are denoted with the same reference symbols.

As FIG. 8 shows, a preamplifier (head IC) 60 is provided near the VCM 18 of the disk enclosure (DE) 1 for enclosing the magnetic disk 12, spindle motor 11, VCM 18 and magnetic head 14 described in FIG. 1. In DE 1, the is temperature/humidity sensor 16 for detecting the temperature and humidity in DE 1 is also disposed.

In a print circuit assembly (control circuit portion) 30, a hard disk controller (HDC) 34, microcontroller (MCU) 33, read/write channel circuit (RDC) 32, servo control circuit 37, data buffer (RAM) 35 and ROM (Read Only Memory) 36 are disposed. In the present embodiment, the HDC 34, MCU 33 and RDC 32 are disposed in one LSI 31.

The read/write channel circuit (RDC) 32 is connected to the preamplifier 60, and controls the data read and data write of the magnetic head 14. In other words, the RDC 32 performs signal shaping, data modulation and data demodulation. The servo control circuit (SVC) 37 controls the driving of the spindle motor 11, and also controls the driving of the VCM 18.

The hard disk controller (HDC) 34 mainly controls the interface protocol, data buffer and disk format. The data buffer (RAM) 35 temporarily stores the read data and write data.

The data buffer 35 stores a flying height control value 38, which is mentioned later in FIG. 10. This flying height control value 38 is stored in the system area of the magnetic disk 11, and is read from the system area of the magnetic disk 11 when the device is started, and is stored in the data buffer (RAM) 35.

The microcontroller (MCU) 33 controls the HDC 34, RDC 32 and SVC 37, and manages the RAM 35 and ROM 35. The ROM 36 stores various programs and parameters.

The preamplifier 60 in FIG. 2 has a read amplifier 64 which amplifies a read signal from the read element 21 (see FIG. 2), and outputs it to the read channel circuit 32, a write amplifier 63 which amplifies a write signal from the read channel circuit 32 and supplies it to the write coil 23, a heater drive circuit 61 which receives a predetermined power amount from the read channel circuit 32 and drives a heating element 22 of the magnetic head 14, and a heater circuit (not illustrated) which controls the heater drive circuit 61.

FIG. 9 is a circuit block diagram depicting the read system of the read channel circuit 32. An output signal (head read signal) from the read amplifier 64 of the preamplifier 60 is amplified by a variable gain amplifier (VGA) 40 of the read channel 32, and is equalized by a variable equalizer 42. Then the equalized signal is sampled by an A/D converter 44 and is converted into digital data, and the data is demodulated in a demodulation circuit 46.

An AGC (Automatic Gain Control) circuit 48 compares the output value of the A/D converter 44 and a reference value, and supplies an AGC control signal (automatic gain control signal) for maintaining the amplifier output amplitude to the variable gain amplifier (VGA) 40 based on the comparison result. The AGC control circuit 48 has a register 50 for holding the AGC control value.

Using this configuration, the flying height is measured in the retraction area (flying guarantee area) 12-1 in which a fixed pattern is recorded, as described in FIG. 7. In other words, the change of the flying height is calculated by Expression (4), which is a combination of the following Expression (2) of Wallace and Expression (3) of the AGC, using the register 50 storing the AGC value of the variable gain amplifier (VGA) 40.

Change of flying height d=λ(2π)×LN (V2/V1) (2)

where λ: wavelength of recorded pattern, V2: reproducing amplitude, V1: initial reproducing amplitude, LN: natural is logarithm Loge.

If the adjustment range of AGC is 64 steps, the reproducing amplitude V is given by the following Expression (3).

Reproducing amplitude V=(⅓)×2^{(AGC register value/64)} (3)

If Expression (3) is substituted in Expression (2), the following Expression (4) is obtained.

d=λ(2π)×LN (2) ((AGC (V2)−AGC (V1))/64) (4)

Therefore the change amount of the flying height can be calculated by Expression (4), if the AGC register value of the initial reproducing amplitude V1, that is the AGC (V1) and the AGC register value of the reproducing amplitude, that is the AGC (V2), are obtained.

FIG. 10 is a flow chart depicting the flying height control processing for describing an embodiment of the present invention. The processing in FIG. 10 is implemented by the MCU 33 in FIG. 8 executing the adjustment program stored in the RAM 35 or ROM 36.

(S10) The MCU 33 monitors the temperature and humidity detected by the temperature/humidity sensor 16. The MCU 33 judges whether the time, when the temperature detected by the temperature/humidity sensor 16 exceeds A° C. (e.g. 60° C.), continued for time t1. The predetermined time t1 is preferably one hour, for example. If the MCU 33 judges that the time, when the temperature detected by the temperature/humidity sensor 16 exceeds A° C. (e.g. 60° C.), continued for time t1, processing advances to step S14.

(S12) If the MCU 33 judges that the time, when the temperature detected by the temperature/humidity sensor 16 exceeds A° C. (e.g. 60° C.), did not continue for time t1, the MCU 33 judges whether the time, when the humidity detected is by the temperature/humidity sensor 16 exceeds B % (e.g. 20%), continued for time t2. The predetermined time t2 is shorter than the first predetermined time t1, and is 10 minutes, for example. If the MCU 33 judges that the time, when the humidity detected by the temperature/humidity sensor 16 exceeds B %, did not continue for time t2, processing returns to step S10.

(S14) If the MCU 33 judges that the time, when the temperature detected by the temperature/humidity sensor 16 exceeds A° C. (e.g. 60° C.), continued for time t1, or judges that the time, when the humidity detected by the temperature/humidity sensor 16 exceeds B %, continued for time t2, it is judged that it is more likely that lubricant has been transferred to the magnetic head and the flying height is increased, as mentioned above. Therefore the MCU 33 instructs the SVC 37 to have the magnetic head 14 seek the outermost position (12-1 in FIG. 7) of the magnetic head 14. By this instruction, the SVC 37 drives the VCM 18 and moves the magnetic head 14 to the retraction area 12-1 of the magnetic head 12 shown in FIG. 7. And the MCU 33 waits for a predetermined time. In this way, by retracting the magnetic head 12 to a position where the circumference speed is fast, the lubricant 100 accumulates less, and an increase in the flying height of the magnetic head 12 can be suppressed.

(S16) In this retraction position (outermost position) 12-1, a fixed pattern is recorded, as mentioned above. It is preferable that the fixed pattern is recorded with a frequency half that of the maximum recording frequency. This is because the change of the reproducing signal with respect to the change of the flying height increases as the frequency becomes higher. However it is preferable to use the second highest recording frequency, since the absolute value of the output is small if the maximum recording frequency is used. The MCU 33 sends a read instruction to the RDC 32, and the RDC 32 receives the read is output for the magnetic head 14 from the preamplifier 60. At this time, as described in FIG. 9, the MCU 33 reads the AGC value of the AGC register 50 of the RDC 32 for one rotation of the magnetic disk 12, and acquires the average value thereof as the AGC register value AGC (V2) of the reproducing amplitude. The AGC register value (V1) of the initial reproducing amplitude in the initial state (e.g. ordinary temperature, ordinary humidity), on the other hand, has been stored as a flying height control value in RAM 30. Therefore the MCU 33 calculates the flying height change in ordinary temperature and ordinary humidity by the Wallace method described in FIG. 9.

(S18) Then the MCU 33 calculates the heater energizing power (flying height control value) with which the calculated flying height change becomes zero, and supplies this power to the heater 22 via the preamplifier 60. And processing ends.

If the high temperature state (e.g. 60° C. temperature) continues, the viscosity of the lubricating film decreases, and the lubricating film is transferred more easily to the magnet head. So the magnetic head is retracted to a position where the circumferential speed is as fast as possible, such as the outermost side of the flying guarantee area of the magnetic disk. The faster the circumferential speed, the less lubricating film transferred onto the surface of the magnetic head adheres and accumulates.

If the absolute humidity exceeds a predetermined value (e.g. 20 g/m³) the absorption amount of the water vapor on the surface of the magnetic disk increases, and as a result, absorption components in the under-layer film decrease, and the film is transferred more easily to the surface of the magnetic head. Therefore the magnetic head is retracted to a position where the circumferential speed is as fast as possible, such as the outermost side of the flying guarantee area of the magnetic disk. The faster the is circumferential speed the less lubricating film transferred onto the surface of the magnetic head adheres and accumulates.

The change of the flying height is measured by the magnetic head moving and reading the fixed pattern recorded in the retraction area 12-1 in advance, and the flying height is corrected for the amount of change. By this, the flying height of the magnetic head can be controlled to the optimum, and the read/write characteristics can be improved.

The flying height measurement method can be either the above mentioned Wallace method or the harmonic ratio method. If the temperature/humidity is higher than a predetermined value, and an access instruction to another area is received for any reason or if there is no choice but for the magnetic head to be retracted (unloaded) outside the magnetic disk, then it is preferable to move the magnetic head to the retraction area before the next operation, and re-measure the flying height. This is because the possibility of causing a change in the flying height is high due to the transfer of the lubricating film to the surface of the magnetic head or the absorption of water vapor, and a correction of the flying height is required.

It is preferable that the flying height in the retraction area is 5 nm or more, and is higher than the flying heights in other areas. If the flying height is lower than 5 nm, the lubricating film tends to be attracted more to the surface of the magnetic head in the area in which the circumferential speed is fast, where the transfer of lubricating film becomes a problem. However as the recording density increases in the future, the flying height must be low, and it is preferable that the restriction of the lower limit of the flying height 5 nm is limited to the retraction area. As a result, it is inevitable that the flying height in the retraction area becomes higher than the flying height in other areas.

When there are a plurality of heads, this adjustment processing is performed for each head so that the flying height control amount is calculated for each head.

Based on the above embodiment, a 2.5 inch 5400 rpm magnetic disk device was evaluated. In order to evaluate acceleration, a header is disposed in the magnetic head, the flying height adjustment is enabled, and the standard flying height is set to 5 nm. Also in order to check the influence of environmental temperature/humidity, the absorbent is removed. The change of the flying height was measured and evaluated for the following examples and the comparative examples.

### EXAMPLE 1

A thermistor (temperature sensor) is installed in the magnetic disk device, and the retraction area is set to an area around a 30.5 nm radius (outermost position), which is a flying guarantee area outside the data area, and the magnetic head is set to be retracted to the retraction area when the temperature is 60° C. or more.

### EXAMPLE 2

In the magnetic disk device in Example 1, a semiconductor temperature sensor and a capacitance type polymer humidity sensor (temperature/humidity sensor) are installed, and the magnetic head is retracted to the retraction area when the absolute humidity is 20 g/m³ or more.

### EXAMPLE 3

In the magnetic disk device in Example 2, a pattern with a frequency half that of the maximum recording frequency is recorded in the retraction area, and the change of the flying height is measured by the Wallace method, and the changed flying height is corrected.

### EXAMPLE 4

In the magnetic disk device in Example 2, the setting of the flying height in the retraction area is changed to 6 nm.

### EXAMPLE 5

In the magnetic disk device in Example 2, the rotation frequency of the magnetic disk in the retraction area is changed to 7200 rpm.

### EXAMPLE 6

In the magnetic disk device in Example 2, PFPE (polyfluoro-polyether) is coated onto the surface of the magnetic head 12 as fluorine contained resin, so as to drop the surface energy to 18 mN/m.

### EXAMPLE 7

In the magnetic disk device in Example 2, a magnetic disk, in which the absorbed components of the lubricating film of the magnetic disk are increased only in the retraction area by UV irradiation, is installed. At this time, the absorbed component ratio is about 80% in the retraction area, and is 70% in the other areas.

### COMPARATIVE EXAMPLE 1

An ordinary magnetic disk device is used which is not modified.

### COMPARATIVE EXAMPLE 2

A thermistor (temperature sensor) is installed in the magnetic disk device, and the retraction area is set to an area around a 21 mm radius, which is a mid-circumference, and the magnetic head is set to be retracted to the retraction area when the temperature is 60° C. or more.

### COMPARATIVE EXAMPLE 3

In the magnetic disk device in Comparative example 2, the retraction area of the magnetic disk device is set to is an area around a 16 mm radius, which is an inner circumference.

### COMPARATIVE EXAMPLE 4

A thermistor (temperature sensor) is installed in the magnetic disk device, and the magnetic head is set to perform seek operation (the magnetic head moves in the radius direction from the constant position) when the temperature is 60° C. or more.

### COMPARATIVE EXAMPLE 5

In the magnetic disk device, a semiconductor temperature sensor and a capacitance type polymer humidity sensor (temperature/humidity sensor) are installed, and the retraction area is set to an area around a 21 mm radius, which is a mid-circumference, and the magnetic head is set to be retracted to the retraction area when the absolute humidity is 20 g/m³ or more.

### COMPARATIVE EXAMPLE 6

In the magnetic disk device in Comparative example 5, the retraction area is set to an area around a 16 mm radius, which is an inner circumference.

### COMPARATIVE EXAMPLE 7

In the magnetic disk device, a semiconductor temperature sensor and a capacitance type polymer humidity sensor (temperature/humidity sensor) are installed, and the magnetic head is set to perform seek operation when the absolute humidity is 20 g/m³ or more.

In the magnetic disk device in Comparative example 1, the magnetic head performs random seek operation under the environments of 60° C. and 20% RH (absolute humidity: 26 g/m³) and 60° C. and 80% RH (absolute humidity: 104 g/m³) , and the change of the flying height vs time is measured. The flying height was measured by the Wallace method by recording the fixed pattern in the outer circumference (30 mm radius).

FIG. 3 shows the result. As mentioned above, the flying height increases as time elapses. Even if the temperature is the same, the change of the flying height increases as the absolute humidity increases.

In the same way, the change of the flying height after a predetermined time elapses was measured using the magnetic disk device in Comparative example 1, with the absolute humidity as a parameter. FIG. 4 shows the result. The change of the flying height increases when the absolute temperature is 20 g/m³ or more. This means that it is preferable that the predetermined value of the absolute humidity for comparison is set to be 20 g/m³.

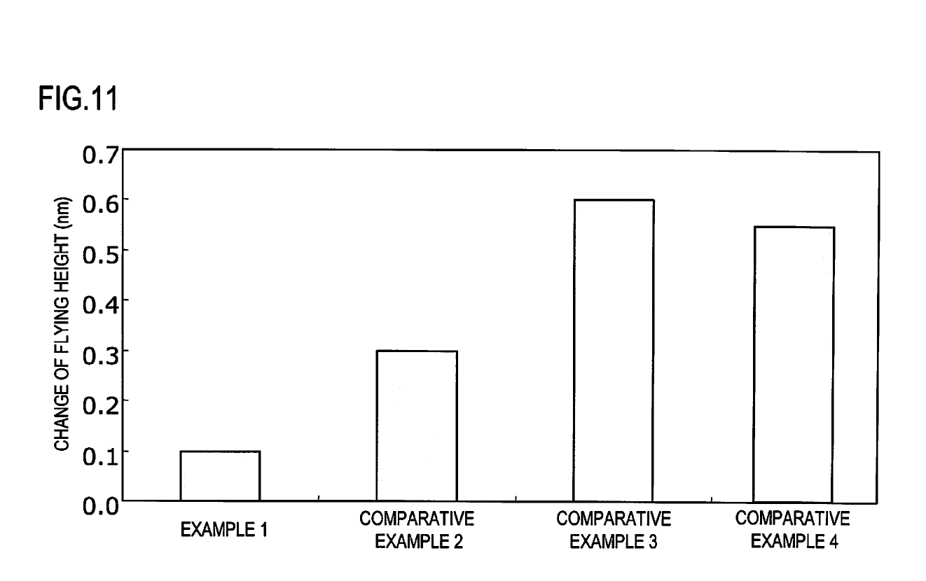

Based on this result, in the environment of 60° C. and 20% RH (absolute humidity: 26 g/m³), a difference between a flying height after a predetermined time elapses and a flying height before the time elapses are measured for each magnetic disk device in Example 1, Comparative example 2, Comparative example 3 and Comparative example 4. These are magnetic devices of which retraction positions are different, or in which seek operation is performed, and FIG. 11 shows the result.

The change of the flying height in Example 1 (retraction position is the outer circumference) is small, but the change amount increases as the circumferential speed in the retraction area becomes slower (as the position is closer to the inside), as shown in Comparative examples 2 and 3 (retraction position is mid-circumference and inner circumference respectively). This is because the faster the circumference speed the less the lubricating film transferred onto the surface of the magnetic head adheres and accumulates.

In the case of performing seek operation, as shown is in Comparative example 4, the change of the flying height is as large as Comparative example 3, since not only the magnetic head passes through an area where the circumferential speed is slow, but also the seek operation itself may change the flying height somewhat. In this way, in a high temperature environment, the change of the flying height differs depending on where the retraction area is located, and it was discerned that the outermost position is appropriate for the retraction area.

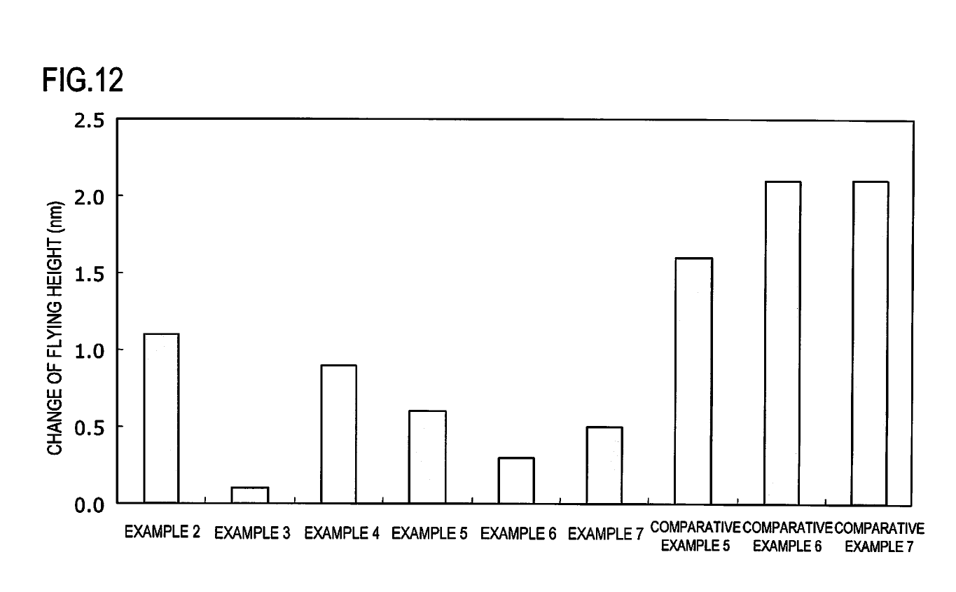

Then in the environment of 60° C. and 80% RH (absolute humidity: 104 g/m³), a difference between a flying height after a predetermined time elapses and a flying height before the time elapses are measured for each magnetic disk device in Example 2 to Example 7, Comparative example 5, Comparative example 6 and Comparative example 7. FIG. 12 is the result.

Just like the result in the case of the low humidity in FIG. 11, in the comparison of Example 2, Example 5, Comparative example 5, Comparative example 6 and Comparative example 7, the change of the flying height is smaller as the circumferential speed in the retraction position is faster, and the change of the flying height increases by seek operation.

The change of the flying height is smaller as the flying height is higher (Example 4), the surface energy is lower (Example 6), and the amount of absorbed components is high (Example 7), and the effect of the present invention is thus confirmed.

### Other Embodiments

In addition to the above embodiments, temporarily increasing the rotation frequency of the magnetic disk can further increase the circumferential speed in the retraction area 12-1 and improve the effect of suppressing the accumulation of lubricating film. There is no specific upper limit of the rotation frequency, but the rotation frequency is preferably about +50% of the ordinary rotation frequency, since increasing frequency causes another problem, such as a rotational splashing of the lubricating film.

A low surface energy film (20 mN/m or less) may be formed on the surface of the magnetic head 12. By using the low surface energy, the adherence of water and lubricating film can be prevented, and an increase of the flying height in a high temperature and high humidity environment can be suppressed. Since the surface energy of the lubricating film itself is low, the transfer of the lubricating film can be decreased if the surface energy on the surface of the magnetic head is 20 mN/m or less.

It is preferable that the film thickness of the lubricating film on the surface of the magnetic disk in the retraction area is lower than the other areas, or the amount of chemical components absorbed to the under-layer film in the retraction area is higher than the other areas. By decreasing the thickness of the lubricating film, the amount of the lubricating film transferred onto the magnetic head can be decreased. Even if the film thickness is the same, a similar effect can be implemented by increasing the amount of components absorbed by the lubricating film and under-layer film.

The flying height may be adjusted by automatic adjustment calibration after the product is shipped, or when a seek command to another position is received. The present invention was described using examples when both temperature and humidity sensors are installed, but in actual practice only one of these sensors may be installed. The flying height measurement method is not limited to the Wallace method, but may be another measurement method, such as the harmonic ratio method.

In the above embodiment, a magnetic disk device in which two magnetic disks are mounted was described, but the present invention can also be applied to a device in which one magnetic disk, or three or more magnetic disks are mounted. In the same way, the magnetic head is not limited to the one shown in FIG. 2, but the present invention can also be applied to other modes of separation type magnetic heads.

The heater drive circuit may be mounted not on the head IC but on the control circuit side, and the magnetic head may include a read element and a heating element.

The present invention includes the inventions added herein below.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has been described in detail, it should be understood that the various changes, substitutions, and alterations could be made hereto without departing from the spirit and scope of the invention.

What is claimed is:

1. A magnetic disk device comprising:
a magnetic head that floats by rotation of a magnetic disk;
an actuator that moves the magnetic head in a radius direction of the magnetic disk;
a temperature sensor that measures a temperature inside an enclosure; and
a control circuit that judges whether a detected temperature of the temperature sensor is a first predetermined value or more, and controls the magnetic head to be retracted to the outermost position of the magnetic disk when the detected temperature is the first predetermined value or more.

2. A magnetic disk device comprising:
a magnetic head that floats by rotation of a magnetic disk;
an actuator that moves the magnetic head in a radius direction of the magnetic disk;
a humidity sensor that measures a humidity inside an enclosure; and
a control circuit that judges whether a detected humidity of the humidity sensor is a predetermined value or more, and controls the magnetic head to be retracted to the outermost position of the magnetic disk when the detected humidity is the predetermined value or more.

3. The magnetic disk device according to claim 1, further comprising a humidity sensor that measures a humidity inside the enclosure, wherein
the control circuit judges whether a detected humidity of the humidity sensor is a second predetermined value or more, and controls the magnetic head to be retracted to the outermost position of the magnetic disk when the detected temperature is the first predetermined value or more and the detected humidity is the second predetermined value or more.

4. The magnetic disk device according to claim 1, wherein the control circuit judges whether the time when the detected temperature is the first predetermined value or more continues for a predetermined time, and controls the magnetic head to be retracted to the outermost position of the magnetic disk when the time continues for the predetermined time.

5. The magnetic disk device according to claim 2, wherein the control circuit judges whether the time when the detected humidity is the predetermined value or more continues for a predetermined time, and controls the magnetic head to be retracted to the outermost position of is the magnetic disk when the time continues for the predetermined time.

6. The magnetic disk device according to claim 3, wherein the control circuit judges whether the time when the detected temperature is the first predetermined value or more continues for a predetermined time, and when the time continues for the predetermined time, judges whether the time when the detected humidity is the second predetermined value or more continues for a second predetermined time, and controls the magnetic head to be retracted to the outermost position of the magnetic disk when the time continues for the second predetermined time.

7. The magnetic disk device according to claim 1, wherein the magnetic head comprises a read element, and
the control circuit causes the read element of the retracted magnetic head to read a fixed pattern recorded in the outermost position of the magnetic disk, calculates a flying height change amount of the magnetic head according to the read output, and calculates a control value of a flying height adjustment mechanism installed in the magnetic head based on the flying height change amount.

8. The magnetic disk device according to claim 1 or claim 2, further comprising a lubricant layer on the surface of the magnetic disk.

9. The magnetic disk device according to claim 7, wherein the flying height adjustment mechanism is a heating unit installed in the magnetic head, and
the control circuit calculates electric power of the heating unit to make the flying height constant.

10. The magnetic disk device according to claim 2, wherein the magnetic head comprises a read element, and
the control circuit causes the read element of the retracted magnetic head to read a fixed pattern recorded in the outermost position of the magnetic disk, calculates a flying height change amount of the magnetic head according to the read output, and calculates a control value of a flying height adjustment mechanism installed in the magnetic head based on the flying height change amount.

11. A flying height control device for a magnetic head for moving a magnetic head that floats by rotation of a magnetic disk using an actuator in a radius direction of the magnetic disk, comprising:
a temperature sensor that measures a temperature inside an enclosure; and
a control circuit that judges whether a detected temperature of the temperature sensor is a first predetermined value or more, and controls the magnetic head to be retracted to the outermost position of the magnetic disk when the detected temperature is the first predetermined value or more.

12. A flying height control device for a magnetic head for moving a magnetic head that floats by rotation of a magnetic disk using an actuator in a radius direction of the magnetic disk, comprising:
a humidity sensor that measures a humidity inside an enclosure; and
a control circuit that judges whether a detected humidity of the humidity sensor is a predetermined value or more, and controls the magnetic head to be retracted to the outermost position of the magnetic disk when the detected humidity is the predetermined value or more.

13. The flying height control device for a magnetic head according to claim 11, further comprising a humidity sensor that measures a humidity inside the enclosure, wherein
the control circuit judges whether a detected humidity of the humidity sensor is a second predetermined value or more, and controls the magnetic head to be retracted to the outermost position of the magnetic disk when the detected is temperature is the first predetermined value or more and the detected humidity is the second predetermined value or more.

14. The flying height control device for a magnetic head according to claim 11, wherein the control circuit judges whether the time when the detected temperature is the first predetermined value or more continues for a predetermined time, and controls the magnetic head to be retracted to the outermost position of the magnetic disk when the time continues for the predetermined time.

15. The flying height control device for a magnetic head according to claim 12, wherein the control circuit judges whether the time when the detected humidity is the predetermined value or more continues for a predetermined time, and controls the magnetic head to be retracted to the outermost position of the magnetic disk when the time continues for the predetermined time.

16. The flying height control device for a magnetic head according to claim 13, wherein the control circuit judges whether the time when the detected temperature is the first predetermined value or more continues for a predetermined time, and when the time continues for the predetermined time, judges whether the time when the detected humidity is the second predetermined value or more continues for a second predetermined time, and controls the magnetic head to be retracted to the outermost position of the magnetic disk when the time continues for the second predetermined time.

17. The flying height control device for a magnetic head according to claim 11, wherein the control circuit causes a read element of the retracted magnetic head to read a fixed pattern recorded in the outermost position of the magnetic disk, calculates a flying height change amount of the magnetic head according to the read output, and calculates a control value of a flying height adjustment mechanism installed in the magnetic head based on the flying height is change amount.

18. The flying height control device for a magnetic head according to claim 11 or claim 12, further comprising a lubricant layer on the surface of the magnetic disk.

19. The flying height control device for a magnetic head according to claim 16, wherein the flying height adjustment mechanism is a heating unit installed in the magnetic head, and
the control circuit calculates electric power of the heating unit to make the flying height constant.

20. The flying height control device for a magnetic head according to claim 12, wherein the control circuit causes a read element of the retracted magnetic head to read a fixed pattern recorded in the outermost position of the magnetic disk, calculates a flying height change amount of the magnetic head according to the read output, and calculates a control value of a flying height adjustment mechanism installed in the magnetic head based on the flying height change amount.
